(19) United States
(12) Patent Application Publication
(10) Pub. No.: US 2004/0079748 A1
(43) Pub. Date: Apr. 29, 2004

(54) Proportional/staging control circuit for heating applications

(76) Inventor: Edward Kenneth Carrick, Houston, TX (US)

Correspondence Address: STEVENS & SHOWALTER LLP, 7019 CORPORATE WAY, DAYTON, OH, 45459-4238, US

(21) Appl. No.: 10/280,236

(22) Filed: Oct. 25, 2002

(51) Int. Cl. H05B 1/02

(52) U.S. Cl. 219/485; 219/492

(57) ABSTRACT

A proportional and staging control circuit is provided for a FPTU including heating element(s) selected so that the maximum heating capacity that can be provided by the unit is the highest practical for its size. Portions of this maximum heating capacity are switch selected for a given application of a FPTU with the switches each corresponding to portions (10% to 100%) of the selected maximum heating capacity so that a portion of the total heating capacity of a FPTU most closely equal to a desired heating capacity can be selected by operation of that switch. Each selected heating capacity is in turn staged with the heating capacity staging again being switch selected. FPTUs including the proportional and staging control are quickly switch configured for a given application without the need of a skilled electrician or technician.

### BACKGROUND OF THE INVENTION

The present invention relates in general to heating, ventilating and air-conditioning (HVAC) systems and, more particularly, to proportional/staging control of electrically powered heating elements used in such systems. While the present invention is generally applicable to a variety of HVAC systems, it will be described herein with reference to fan powered terminal units for which it is initially being used.

Fan powered terminal units are used for both cooling and heating of perimeter zones of a building. Terminal units use the free heat derived from lighting, people and other equipment within the building by inducing this warmer air from a building core ceiling plenum space and recirculating it to rooms calling for heat. When additional heat is required, supplemental electric heating coils within the terminal units are activated thus eliminating the need for a central source of warm air.

Conventionally, the electric heating coils for terminal units are wound and sized to meet specific project heat capacity requirements. The end result is that a fan powered terminal unit (sometimes referred to as a FPTU) must be custom built to order which extends ship times so that terminal unit products can not be delivered within a short lead time. To accommodate markets that require short lead times, such as tenant work, which tends to be extremely fast paced, sometimes requiring overnight delivery of fan powered terminal units, some “stock” units are commercially offered. “Stock” fan powered terminal units are wired to provide a variety of heater configurations based on terminations of selected jumper wires and pins.

The “stock” FPTUs can be configured/reconfigured using the jumper wires and pins to provide a number of options including different wattages, voltages and voltage phases, and differing numbers of heating stages. Heating stages, as used herein, refers to being able to control heating element(s) so that they provide portions of a maximum heat available from the heating element(s) with the heating element(s) being controlled in “stages” for more accurate and even environment control. The most coarse staging is one stage operation which provides a heater off state and a heater fully on stage (100%). Two stage operation provides a heater off state, a partially on stage (e.g., 50%) and a fully on stage (100%), and three stage operation provides the generally highest heat resolution with a heater off state, a first partially on stage (e.g., 33%), a second, higher partially on stage (e.g., 67%) and a fully on stage (100%). While the “stock” FPTUs satisfy, to some extent, the requirements for short lead time terminal units, unfortunately their configuration/reconfiguration is complex requiring a skilled electrician or technician and the units offer a fairly limited number of options for tenant work and other applications requiring quick delivery of terminal units.

There is, thus, a need for a general-purpose fan powered terminal unit that provides an easily selectable heat capacity up to a maximum heat capacity. Preferably, these units would also allow simplified selection of heat staging of any selected heat capacity provided by the FPTU.

### SUMMARY OF THE INVENTION

This need is met by a heating element control circuit used, for example in a fan powered terminal unit (FPTU), structured and operated in accordance with the present invention. When used in an FPTU, the FPTU includes one or more heating elements selected so that the maximum heating capacity that can be provided by the unit is the highest practical for the size of the unit. By using switches, portions of this maximum or total heating capacity of a FPTU can then be selected by the control circuit for a given application. The switches each correspond to portions (10% to 100% in the illustrated embodiment) of the total heating capacity of the unit so that a portion of the total heating capacity most closely equal to a desired heating capacity can be selected by operation of that switch without the need for a skilled electrician or technician to adjust selected jumper wires and pins. In the illustrated embodiment, each selected heating capacity can in turn be staged with the heating capacity staging again being switch selected without the need for a skilled electrician or technician. In this way, FPTUs including the invention of the present application can be quickly switch configured for a given application and rapidly, conveniently and inexpensively provided for markets that require short lead times, such as tenant work, which tends to be extremely fast paced, sometimes requiring overnight delivery of fan powered terminal units.

In accordance with one aspect of the present invention, a circuit for controlling operation of a heating element comprises a source for a plurality of power signals each of the power signals corresponding to a portion of total power available from a heating element to be controlled. A selector is provided for choosing one of the plurality of power signals corresponding to a maximum power to be delivered by the heating element to be controlled. The chosen one of the plurality of power signals is selectively interconnected to the heating element to be controlled by a connector. The connector may comprise at least one switch contact and the source for a plurality of power signals may comprise a voltage divider circuit with the plurality of power signals corresponding to voltages generated by the voltage divider circuit. The selector may comprise a switching device connected between the plurality of power signals and the connector. The switching device may comprise a plurality of switches connected between the plurality of power signals and the connector and, as illustrated, comprises a dual inline package (DIP) switch. The circuit may further comprise a source for at least one power staging signal for providing at least one power staging signal corresponding to a portion of the total power available from the heating element to be controlled for the chosen one of the plurality of power signals and, in that event, the connector selectively interconnects the chosen one of the plurality of power signals and the power staging signal to the heating element to be controlled. The at least one power staging signal may be derived from the chosen one of the plurality of power signals. In the illustrated embodiment, the source for a plurality of power signals comprises a first voltage divider circuit, and the plurality of power signals correspond to voltages generated by the first voltage divider circuit. For this embodiment, the source for at least one power staging signal comprises a second voltage divider circuit receiving and dividing the output of the first voltage divider circuit with the at least one power staging signal corresponding to at least one voltage generated by the second voltage divider circuit. The connector may comprise a control interface circuit for converting the chosen one of the plurality of power signals to a signal compatible for control of the heating element to be controlled. For example, the control interface circuit may comprise a duty cycle modulator for generating a pulse width modulated signal.

In accordance with another aspect of the present invention, a method for controlling operation of a heating element comprises generating a plurality of power signals, each corresponding to a given power level to be provided to a heating element to be controlled. One of the power signals corresponding to a required power level for the heating element to be controlled is selected and the selected power signal is connected to the heating element to be controlled. The method may further comprise generating at least one power staging signal corresponding to the selected power signal. If so, the step of connecting the selected power signal to the heating element to be controlled comprises connecting the selected one of the power signals and the at least one power staging signal to the heating element to be controlled based on power staging management. As illustrated, the generation of at least one power staging signal comprises the step of dividing the power signal.

In accordance with yet another aspect of the present invention, a method for controlling operation of a heating element comprises generating a plurality of power signals defining a corresponding plurality of power levels to be provided to a heating element to be controlled. One of the power signals corresponding to a required power level for the heating element to be controlled is selected and the selected power signal is divided into at least one power staging signal corresponding to a portion of the required power level for the heating element to be controlled. The selected one of the power signals and the at least one power staging signal are connected to the heating element to be controlled. The generation of a plurality of power signals may comprise dividing a first voltage into a plurality of voltages, the plurality of voltages corresponding to the plurality of power levels to be provided to the heating element to be controlled. The division of the selected power signal into at least one power staging signal may comprise dividing one of the plurality of voltages corresponding to the selected one of lo the power signals, the at least one power staging signal corresponding to at least one voltage resulting from dividing the one of the plurality of voltages corresponding to the selected one of the power signals.

In accordance with still another aspect of the present invention, a method for controlling operation of a heating element having a maximum heating capacity comprises selecting a heating capacity for a heating element to be controlled, the selected heating capacity being equal to or less than the maximum heating capacity. A power signal corresponding to the selected heating capacity is generated and the power signal is connected to the heating element to be controlled. The method may further comprise selecting at least one power staging heating capacity for staging the selected heating capacity with the selected at least one power staging heating capacity comprising a fractional portion of the selected heating capacity. At least one power staging signal corresponding to the at least one power staging heating capacity is generated and the at least one power staging signal is connected to the heating element to be controlled.

Other aspects and advantages of the invention will be apparent from the following description, the accompanying drawings and the appended claims.

### BRIEF DESCRIPTION OF THE DRAWINGS

FIG. 1 is a system level view of the heater and heater control portion of a fan powered terminal unit (FPTU) including a proportional and staging control in accordance with the illustrated embodiment of the present invention; and

FIGS. 2a-2c are a schematic diagram of the proportional and staging control of the FPTU of FIG. 1.

### DETAILED DESCRIPTION OF THE INVENTION

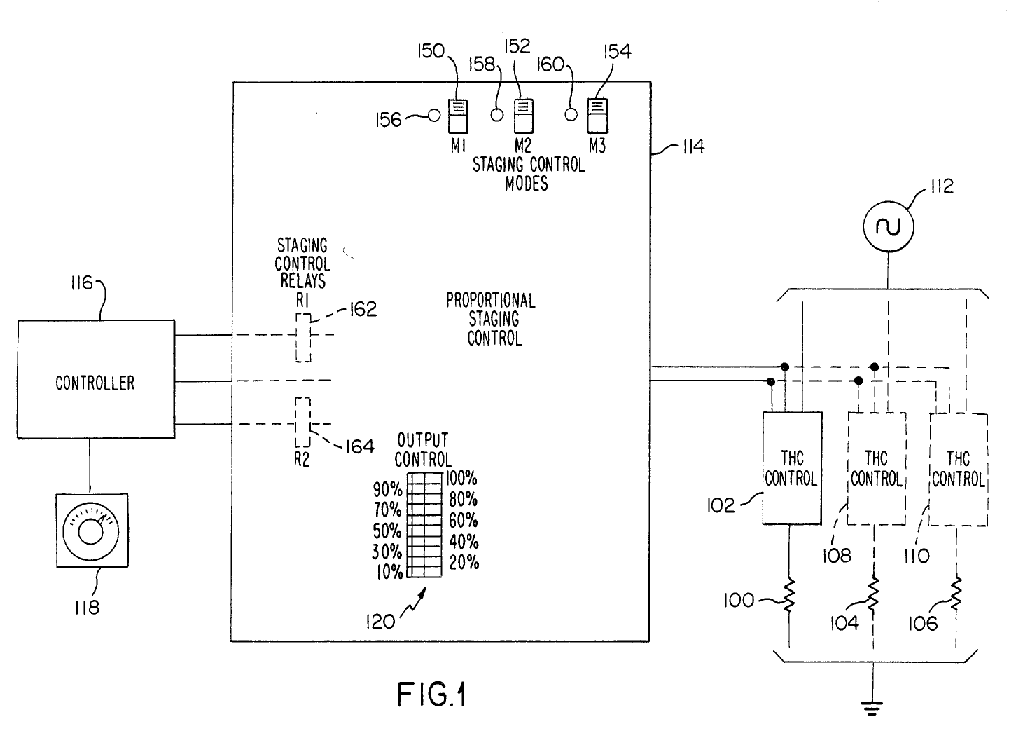

While the present invention is generally applicable to a variety of HVAC systems, it will be described herein with reference to a fan powered terminal unit (FPTU) for which it is initially being used. With reference to FIG. 1, operation of a heating element 100 is controlled via a thyristor heater control (THC) 102. If multi-phase power (three phase power illustrated) is to be used, two additional heating elements 104, 106 are provided with corresponding thyristor controllers 108, 110, illustrated in FIG. 1 by dotted lines. The thyristor heater control(s) 102, 108, 110 selectively conduct power from a source of alternating current (ac) 112 to the heating element(s) 100, 104, 106. Suitable thyristor or SCR (silicon controlled rectifier—a form of thyristor known as a reverse-blocking triode thyristor) controllers are commercially available from a variety of sources including, for example, Crotec Electronic Controls of Oliver Springs, Tenn. The thyristor heater control(s) 102, 108, 110 are controlled by signals generated by the proportional staging control 114 of the present invention. The number of heating elements and thyristor controllers used in a given FPTU can vary depending not only on whether single or multi-phase power is to be used but also upon heating element configurations and the like as will be apparent to those skilled in the art.

Heat control for the illustrated embodiment is provided by an external controller 116 that receives heat request signals from a separate thermostat 118. While the thermostat 118 as illustrated is separate from the controller 116, it can be included in the controller 116. A wide variety of thermostats are commercially available as are a wide variety of controllers, both analog and digital. In addition, it is noted that heat control can be provided by a variety of commercially available devices operating with a variety of temperature sensors. Accordingly, since these devices are commercially available, are well known in the art and form no part of the present invention, they will be described herein only as necessary for an understanding of the present invention.

An FPTU structured and controlled in accordance with the present invention includes one or more heating elements selected so that the maximum heating capacity that can be provided by the unit is the highest practical for the size of the unit. Portions of this maximum or total heating capacity can then be selected for a given application of an FPTU using switches. The switches each correspond to portions (10% to 100% in the illustrated embodiment) of the total heating capacity of the unit so that a portion of the total heating capacity most closely equal to a desired heating capacity can be selected by operation of that switch without the need for a skilled electrician or technician to adjust selected jumper wires and pins. In the illustrated embodiment, each selected heating capacity can in turn be staged with the heating capacity staging again being switch selected without the need for a skilled electrician or technician. In this way, FPTUs including the invention of the present application can be quickly switch configured for a given application and rapidly, conveniently and inexpensively provided for markets that require short lead times, such as tenant work, which tends to be extremely fast paced, sometimes requiring overnight delivery of fan powered terminal units.

Staging the heating capacity or power staging, as used herein, refers to being able to control heating element(s) 100, 104, 106 so that the selected maximum heat capacity is provided proportionally as required, i.e., portions of the selected maximum heat capacity are in turn selected as needed for more accurate and even heat control. While any number of stages can be provided, the most common are one, two and three stage heating which are illustrated and will be used to describe the present invention. One stage operation is the most coarse staging with operation that provides a heater off state and a heater fully on stage (100%). Two stage operation is an intermediate level of staging that provides a heater off state, a partially on stage (e.g., 50%) and a fully on stage (100%), and three stage operation provides the finest heat resolution with a heater off state, a first partially on stage (e.g., 33%), a second, higher partially on stage (e.g., 67%) and a fully on stage (100%).

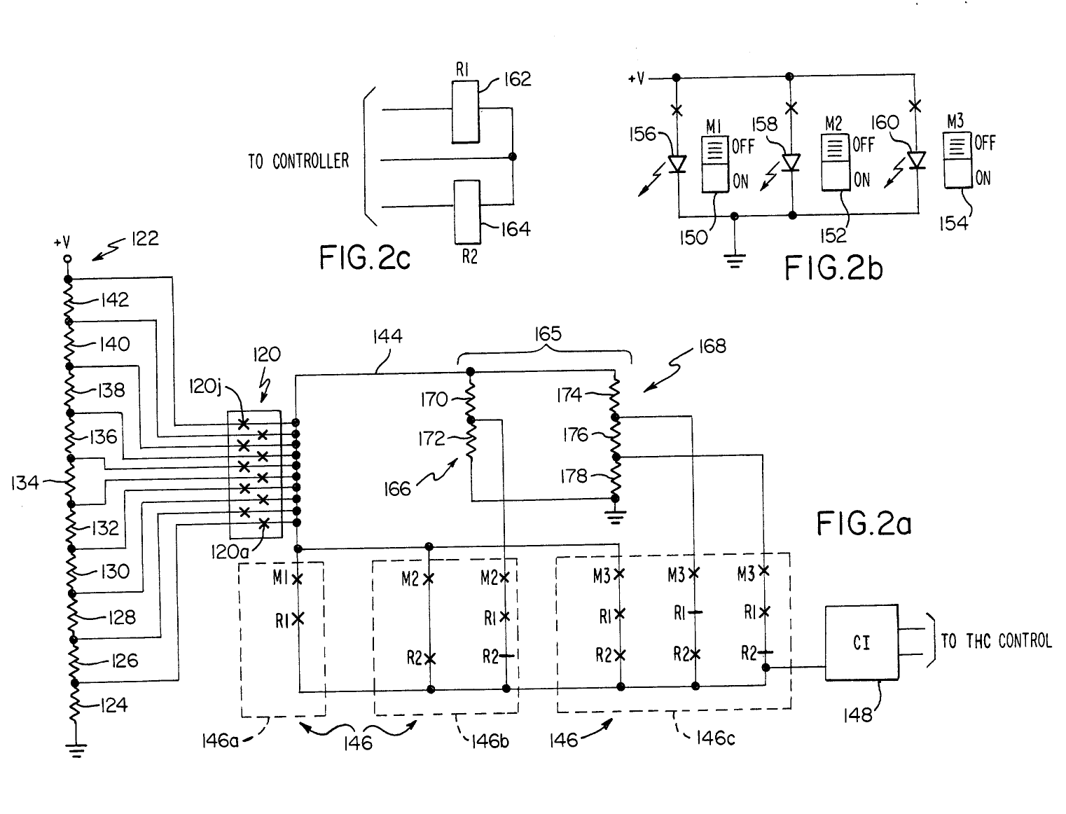

With reference to FIGS. 1 and 2a-2c, the proportional and staging control 114 of the illustrated embodiment comprises a series of switches 120 for selecting portions (10% to 100%) of the total heating capacity that is provided by the heating element(s) 100, 104, 106. In FIG. 2a, normally open contacts of the switches 120 are represented by an “X” formed on a line representative of an electrical conductor. For cost and size considerations, the switches 120 comprise a dual inline package (DIP) switch, as illustrated in FIG. 1. However, other switches, both mechanical and electronic, are contemplated for use in the present invention and, while ten portions of the total heating capacity, 10%-100% in 10% increments, is illustrated, more than ten switches or less than ten switches can be used as well as other percentages or fractional divisions of the total power.

As shown in FIG. 2a, the switches 120 are connected to different voltage levels along and defined by a voltage divider circuit 122 which comprises a source for a plurality of power signals each corresponding to a portion of the total power available from the heating element(s) 100, 104, 106 to be controlled. The illustrated voltage divider circuit 122 comprises ten resistors 124-142 each being of substantially the same resistance value, for example 10K ohms for a voltage +V of +12 volts. Thus, when the switch 120a is operated, 10% of the voltage +V defines one of the power signals and corresponds to the selection of 10% of the total heating capacity, when the switch 120j is operated, 100% of the voltage +V defines one of the power signals and corresponds to the selection of 100% of the total heating capacity and the switches in between 120b-120i define the remaining power signals corresponding to the selection of 20%-90% of the total heating capacity. For proper operation of the illustrated embodiment, only one of the switches 120 is to be operated. Of course, other switch coding arrangements can be used wherein one, two or more switches are operated at the same time to define a selected portion of the total heating capacity.

When one of the switches 120 is operated, it serves as a selector for choosing the corresponding voltage (power signal) on the input of the switch and connecting it to the output of the switch. The outputs of the switches 120 are all interconnected at a node 144. A connector 146 is provided for connecting the voltage (power signal) on the node 144 to the heating element(s) 100, 104, 106. In the illustrated embodiment, the connector 146 comprises a series of switch contacts M1, M2, M3, corresponding to M1-M3 mode switches 150, 152, 154, respectively, and relay contacts R1, R2, corresponding to the R1 relay 162 and the R2 relay 164, respectively. The connector 146 connects the chosen voltage (power signal) to the heating element(s) 100, 104, 106 via a control interface (CI) 148 that processes the voltage (power signal) into a signal that is appropriate for operation of the thyristor heater control(s) 102, 108, 110, e.g., a direct current (dc) voltage within an appropriate voltage range, a dc current signal within an appropriate range, a pulse width modulated signal, and the like. When a pulse width modulated signal is provided, a visual indication of the modulation level of the signal can be provided using a light emitting diode (not shown) or the like. An appropriate control interface can be provided in the thyristor heater control(s) 102, 108, 110 or can be separately provided as illustrated in the present application and these, as well as other implementations that will be apparent to those skilled in the art, are contemplated for use in the present invention. Designs for control interfaces are well known in the art such that they will not be described further herein.

Since the illustrated embodiment provides not only proportional control but also staging control of any selected heat capacity or power level, the connector 146 includes three sections: connector section 146a for one stage control, identified as mode 1 and selected by operation of the mode 1 switch 150; connector section 146b for two stage control, identified as mode 2 and selected by operation of the mode switch 152; and, connector section 146c for three stage control, identified as mode 3 and selected by operation of the mode switch 154, see FIG. 2b. Operation of one of the mode switches 150, 152, 154 generates a corresponding visible indication by activation of one of light emitting diodes (LEDs) 156, 158, 160 in the illustrated embodiment. Of course other indications, visible and audible, can be provided. Normally open contacts M1, M2, M3 of the mode switches 150, 152, 154 are represented by an “X” on a conductor indicating that the path through the conductor is open when the switch is off and is closed when the switch is on. The connector 146 also includes contacts of the R1 relay 162 and the R2 relay 164, see FIGS. 1 and 2c. The relays 162, 164 are shown in dotted lines in FIG. 1 since the proportional staging control 114 is formed as a circuit board in the illustrated embodiment and the relays 162, 164 are located on the back side of the circuit board as shown in FIG. 1. Normally open contacts R1 and R2 of the relays 162, 164 are again represented by an “X” on a conductor indicating that the electrical path through the conductor is open when the relay is not operated and is closed when the relay is operated while normally closed contacts R1 and R2 of the relays 162, 164 are represented by a “I” across a conductor indicating that the electrical path through the conductor is closed when the relay is not operated and is open when the relay is operated.

For staging purposes in the illustrated embodiment, the power signal or voltage on the node 144 is divided by a second voltage divider circuit 165 made up of two voltage dividers 166, 168. The illustrated voltage divider circuit 166 generates a power staging signal corresponding to mode 2 staging operation (two stage operation) and comprises two resistors 170, 172 each being of substantially the same resistance value, for example 30K ohms for a voltage +V of +12 volts. The illustrated voltage divider circuit 168 generates power staging signals corresponding to mode 3 staging operation (three stage operation) and comprises three resistors 174, 176, 178 each being of substantially the same resistance value, for example 30K ohms for a voltage +V of +12 volts. Thus, the second voltage divider circuit 165 takes the voltage representative of the power signal on the node 144 (the selected maximum or total heat capacity or power for the FPTU) and divides that voltage to generate voltages or power staging signals that are connected to the heating element(s) 100, 104, 106 by the connector 146 through the control interface (CI) 148.

Operation of an FPTU incorporating the proportional staging of the present application will now be described. For mode 1 power staging, the M1 mode switch 150 is operated, i.e., switched on, (the M2 and M3 mode switches 152, 154 are in their off positions) to close the M1 normally open contacts activating the LED 156 for visibly indicating operation of the M1 mode switch 150 and enabling connector section 146a for one stage control operation. For zero heat, neither of the R1 or R2 relays is operated and so no power signal is provided to the heating element(s) 100, 104, 106. For heat in mode 1 power staging, the R1 relay is operated (while the R2 relay will normally not be controlled for mode 1 operation, in the illustrated embodiment, the status of the R2 relay is indicated as “don't care” as it can be either operated or non-operated) closing the R1 relay normally open contacts (and opening the R1 normally closed contact) so that the connector section 146a connects the power signal representing 100% of the maximum power or total power to be provided by the FPTU (power signal selected by one of the switches 120 and connected to the node 144) to the heating element(s) 100, 104, 106 as described above. This operation is represented by the following table:

MODE 1

STAGING
CONTROL

| % HEAT | R1 | R2 |
|---|---|---|
| 0 | NON-OP | NON-OP |
| 100 | OP | DON'T |
| | | CARE |

For mode 2 power staging, the M2 mode switch 152 is operated, i.e., switched on, (the M1 and M3 mode switches 150, 154 are in their off positions) to close the M2 normally open contacts activating the LED 158 for visibly indicating operation of the M2 mode switch 152 and enabling connector section 146b for two stage control operation. For zero heat, neither the R1 or R2 relays is operated and so no power signal is provided to the heating element(s) 100, 104, 106. In the illustrated embodiment, heat is provided in mode 2 power staging in two stages—50% and 100%. For 50% of the maximum power or total power (power signal selected by one of the switches 120 and connected to the node 144) to be provided by the FPTU, the R1 relay is operated (the R2 relay is non-operated or is released if operated) closing the R1 relay normally open contacts (and opening the R1 relay normally closed contact) so that the connector section 146b connects the power signal produced by the voltage divider 166 representing 50% of the selected maximum power or total power to be provided by the FPTU to the heating element(s) 100, 104, 106 as described above. For 100% of the selected maximum power or total power to be provided by the FPTU, the R2 relay is operated (while the R1 relay can be operated for 100% power in mode 1 operation, in the illustrated embodiment, the status of the R1 relay is indicated as “don't care” as it can be either operated or non-operated) closing the R2 relay normally open contacts and opening the R2 normally closed relay contacts so that the connector section 146b connects the power signal representing 100% of the selected maximum power or total power to be provided by the FPTU to the heating element(s) 100, 104, 106 as described above. This operation is represented by the following table:

MODE 2

STAGING
CONTROL

| % HEAT | R1 | R2 |
|---|---|---|
| 0 | NON-OP | NON-OP |
| 50 | OP | NON-OP |
| 100 | DON'T | OP |
| | CARE | |

For mode 3 power staging, the M3 mode switch 154 is operated, i.e., switched on, (the M1 and M2 mode switches 150, 152 are in their off positions) to close the M3 normally open contacts activating the LED 160 for visibly indicating operation of the M3 mode switch 154 and enabling the connector section 146c for three stage control operation. For zero heat, neither of the R1 or R2 relays is operated and so no power signal is provided to the heating element(s) 100, 104, 106. In the illustrated embodiment, heat is provided in mode 3 power staging in three stages—33%, 67% and 100%. For 33% of the maximum power or total power (power signal selected by one of the switches 120 and connected to the node 144) to be provided by the FPTU, the R1 relay is operated (the R2 relay is non-operated or is released if operated) closing the R1 relay normally open contacts (and opening the R1 normally closed contact) so that the connector section 146c connects the power signal produced by the voltage divider 168 representing 33% of the selected maximum power or total power to be provided by the FPTU the heating element(s) 100, 104, 106 as described above. For 67% of the selected maximum power or total power to be provided by the FPTU, the R2 relay is operated (the R1 relay is non-operated or released if operated) closing the R2 normally open relay contacts (and opening the R2 normally closed relay contacts) so that the connector section 146c connects the power signal produced by the voltage divider 168 representing 67% of the selected maximum power or total power to be provided by the FPTU to the heating element(s) 100, 104, 106 as described above. For 100% of the selected maximum power or total power to be provided by the FPTU, both the R1 relay and the R2 relay are operated closing the R1 and R2 relay normally open contacts and opening the R1 and R2 relay normally closed contacts so that the connector section 146b connects the power signal representing 100% of the selected maximum power or total power to be provided by the FPTU to the heating element(s) 100, 104, 106 as described above. This operation is represented by the following table:

MODE 3

STAGING
CONTROL

| % HEAT | R1 | R2 |
|---|---|---|
| 0 | NON-OP | NON-OP |
| 33 | OP | NON-OP |
| 67 | NON-OP | OP |
| 100 | OP | OP |

It is noted that the staging selection signals provided to the proportional staging control 114 by the external controller 116 are conventionally generated, form no part of the present invention and their generation will not be described herein. While operation of the proportional staging control 114 of the present application to provide quick, convenient and inexpensive selection of the heating capacity of FPTUs, including the staging of that selected heating capacity, by means of simple operations of switches without the need for a skilled electrician or technician is apparent from the above description, this operation will now be described for the sake of clarity of the present application.

In its broadest aspects, the process or method for controlling operation of a heating element comprises generating a plurality of power signals, each corresponding to a given power level to be provided to a heating element to be controlled, selecting one of the power signals corresponding to a required power level for the heating element to be controlled, and connecting the selected power signal to the heating element to be controlled. In the illustrated embodiment, at least one power staging signal corresponding to the selected power signal is generated and the selected one of the power signals and the at least one power staging signal are connected to the heating element to be controlled based on power staging management. Also as illustrated, the power signals are generated as voltage levels produced by a voltage divider and the staging signals are generated by dividing the voltage levels corresponding to the selected power signal.

Having thus described the invention of the present application in detail and by reference to preferred embodiments thereof, it will be apparent that modifications and variations are possible without departing from the scope of the invention defined in the appended claims.

What is claimed is:

1. A circuit for controlling operation of a heating element comprising:
a source for a plurality of power signals each of said power signals corresponding to a portion of total power available from a heating element to be controlled;
a selector for choosing one of said plurality of power signals corresponding to a maximum power to be delivered by the heating element to be controlled; and
a connector for selectively interconnecting said chosen one of said plurality of power signals to the heating element to be controlled.

2. A circuit as claimed in claim 1 wherein said connector comprises at least one switch contact.

3. A circuit as claimed in claim 1 wherein said source for a plurality of power signals comprises a voltage divider circuit, and said plurality of power signals correspond to voltages generated by said voltage divider circuit.

4. A circuit as claimed in claim 1 wherein said selector comprises a switching device connected between said plurality of power signals and said connector.

5. A circuit as claimed in claim 4 wherein said switching device comprises a plurality of switches connected between said plurality of power signals and said connector.

6. A circuit as claimed in claim 5 wherein said switching device comprises a dual inline package switch.

7. A circuit as claimed in claim 1 further comprising a source for at least one power staging signal for providing at least one power staging signal corresponding to a portion of the total power available from the heating element to be controlled for said chosen one of said plurality of power signals, said connector selectively interconnecting said chosen one of said plurality of power signals and said power staging signal to the heating element to be controlled.

8. A circuit as claimed in claim 7 wherein said at least one power staging signal is derived from said chosen one of said plurality of power signals.

9. A circuit as claimed in claim 7 wherein said source for a plurality of power signals comprises a first voltage divider circuit, and said plurality of power signals correspond to voltages generated by said first voltage divider circuit.

10. A circuit as claimed in claim 9 wherein said source for at least one power staging signal comprises a second voltage divider circuit receiving and dividing the output of said first voltage divider circuit, said at least one power staging signal corresponding to at least one voltage generated by said second voltage divider circuit.

11. A circuit as claimed in claim 1 wherein said connector comprises a control interface circuit for converting said chosen one of said plurality of power signals to a signal compatible for control of the heating element to be controlled.

12. A circuit as claimed in claim 11 wherein said control interface circuit comprises a duty cycle modulator for generating a pulse width modulated signal.

13. A method for controlling operation of a heating element comprising the steps of:
generating a plurality of power signals, each corresponding to a given power level to be provided to a heating element to be controlled;
selecting one of said power signals corresponding to a required power level for the heating element to be controlled; and
connecting said selected power signal to the heating element to be controlled.

14. A method as claimed in claim 13 further comprising the steps of:
generating at least one power staging signal corresponding to said selected power signal; and
said step of connecting said selected power signal to the heating element to be controlled comprising the step of connecting said selected one of said power signals and said at least one power staging signal to the heating element to be controlled based on power staging management.

15. A method as claimed in claim 13 wherein said step of generating at least one power staging signal comprises the step of dividing said power signal.

16. A method for controlling operation of a heating element comprising the steps of:
generating a plurality of power signals defining a corresponding plurality of power levels to be provided to a heating element to be controlled;
selecting one of said power signals corresponding to a required power level for the heating element to be controlled;
dividing said selected power signal into at least one power staging signal, said at least one power staging signal corresponding to a portion of said required power level for the heating element to be controlled; and
connecting said selected one of said power signals and said at least one power staging signal to the heating element to be controlled.

17. A method as claimed in claim 16 wherein said step of generating a plurality of power signals comprises the step of dividing a first voltage into a plurality of voltages, said plurality of voltages corresponding to said plurality of power levels to be provided to said heating element to be controlled.

18. A method as claimed in claim 17 wherein said step of dividing said selected power signal into at least one power staging signal comprises the step of dividing one of said plurality of voltages corresponding to said selected one of said power signals, said at least one power staging signal corresponding to at least one voltage resulting from dividing said one of said plurality of voltages corresponding to said selected one of said power signals.

19. A method for controlling operation of a heating element having a maximum heating capacity, said method comprising the steps of:
selecting a heating capacity for a heating element to be controlled, said selected heating capacity being equal to or less than said maximum heating capacity;
generating a power signal corresponding to said selected heating capacity; and
connecting said power signal to the heating element to be controlled.

20. A method as claimed in claim 19 further comprising the steps of:
selecting at least one power staging heating capacity for staging said selected heating capacity, said selected at least one power staging heating capacity comprising a fractional portion of said selected heating capacity;
generating at least one power staging signal corresponding to said at least one power staging heating capacity; and
connecting said at least one power staging signal to the heating element to be controlled.
